(19) United States
(12) Patent Application Publication
(10) Pub. No.: US 2003/0225682 A1
(43) Pub. Date: Dec. 4, 2003

(54) Competitive bidding in an EDA advertising system

(75) Inventor: William A. Montemer, Long Beach, CA (US)

Correspondence Address: SOCAL IP LAW GROUP, 310 N. WESTLAKE BLVD. STE 120, WESTLAKE VILLAGE, CA, 91362, US

(73) Assignee: INTERCHANGE CORP.

(21) Appl. No.: 10/448,807

(22) Filed: May 30, 2003

Related U.S. Application Data
(63) Continuation of application No. 60/384,963, filed on Jun. 3, 2002.

(51) Int. Cl. G06F 17/60

(52) U.S. Cl. 705/37

(57) ABSTRACT

Directory assistance provides telephone number look up services to callers based on the business or caller name as listed in a telephone directory. Enhanced directory assistance services provide opportunities for telephone listing owners and advertisers to promote their products and services to telephone callers looking for the same. The present invention provides a method and system whereby the order in which directory listings appear and are offered to callers is controlled by a competitive auction process. The competitive process thus creates a commercial marketplace for the position of a listing in a directory assistance inquiry. The present invention also provides a method and system for administering and dynamically maintaining this directory assistance listing marketplace.

### RELATED APPLICATION INFORMATION

This application claim priority from US Provisional Patent Application No. 60/384/963 filed Jun. 3, 2002 and which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention generally- relates to the field of telecommunications, and particularly relates to a system and method for providing advertising opportunities in directory assistance systems.

2. Description Of Related Art

Telephone Directory Assistance has been around as long as there have been telephone operators. Once the number of telephone subscribers reached two and three digits, telephone directories were published as service to the large numbers of telephone subscribers. These published telephone directories or books helped both the subscribers and telephone operators locate and contact other telephone subscribers.

There are two types of telephone directories. The White Page-styled directory lists basic telephone contact information for all telephone subscribers; basic listings are free to all subscribers and subscribers are listed by name. The Yellow Page-styled directory lists products and services by category, to be included in a Yellow Page directory an advertiser must pay a fee. The Yellow Page directory advertiser pays for both the size of the advertisement or listing and for its inclusion in one or more specific categories.

Traditional directory assistance service provides telephone number look up to the White page style directory. Enhanced directory assistance service provides look up to a Yellow Page style directory. The difference between the two is based on how a caller finds a particular directory listing.

In a traditional directory assistance service, the caller contacts a directory assistance operator and gives the operator the name of a business or person and its associated locale. The directory assistance operator then searches a telephone directory database for a telephone listing that matches the sought-after criteria. Upon finding a match or a set of matches, the operator informs the caller and either gets further information to narrow the results or offers to connect the caller to a desired telephone number.

In an enhanced directory assistance system, a caller contacts a directory assistance operator and in addition to providing as some localization information to narrow where the caller wishes to find the product or services, the caller provides a category name or keyword associated with the desired product or service. In the present art, an enhanced directory assistance operator then takes the provided information and searches or queries a Yellow Page-styled directory. Upon finding a match, the operator informs the caller and either gets further information to narrow the results or offers to connect the caller to the desired telephone number.

In the present art, inclusion in these paid listings is offered to a business or organization through monthly or yearly subscription fees. Also in the present art, listing partners can pay a premium fee to be listed at the top of a category or keyword lookup result list. The premium or preferred listing is given priority treatment by the directory assistance and mentioned before any other paid listings are communicated.

In the present art, directory listings are static and the ordering is based on non-parameters varying parameters such as alphabetical business name. Using the current directory assistance systems as advertising resources would result in a very static advertising channel.

The present invention adds a dynamic element to the listing ordering process. Also, the advertiser maintained bidding mechanism allows the list position to be controlled by basic market forces in which the price of the more desired positions rises according to the price advertisers wish to pay.

### DESCRIPTION OF THE DRAWINGS

FIG. 1A is a system block diagram of an Enhanced Directory Assistance (EDA) Listing Marketplace.

FIG. 1B is a system block diagram of the Customer System in an automated EDA Listing Marketplace implementation.

FIG. 2 is a a diagram of an EDA Listing Database implementation.

FIGS. 3A and 3B are flow charts showing how the competitive bidding process for directory listings works.

FIG. 4 is a site diagram of an EDA Web Application.

FIG. 5 is a flow chart showing the login and web application access procedure for an advertiser account.

FIG. 6A is a screen shot of a personalized advertiser homepage screen implementation.

FIG. 6B is a screen shot of a homepage screen implementation for an administrator.

FIG. 7 is a flow chart of an Update Keyword Bids operation.

FIG. 8 is a screen shot of an Update Keyword Bids screen.

### DETAILED DESCRIPTION OF THE INVENTION

Throughout this description, the embodiments and examples shown should be considered as exemplars, rather than limitations on the apparatus and methods of the present invention.

Enhanced Directory Assistance (EDA) services provide opportunities for telephone listing owners and advertisers to promote their products and services to telephone callers looking for the same products and services. The EDA system disclosed here provides a commercial system and method for ordering and maintaining directory listings as advertising resources.

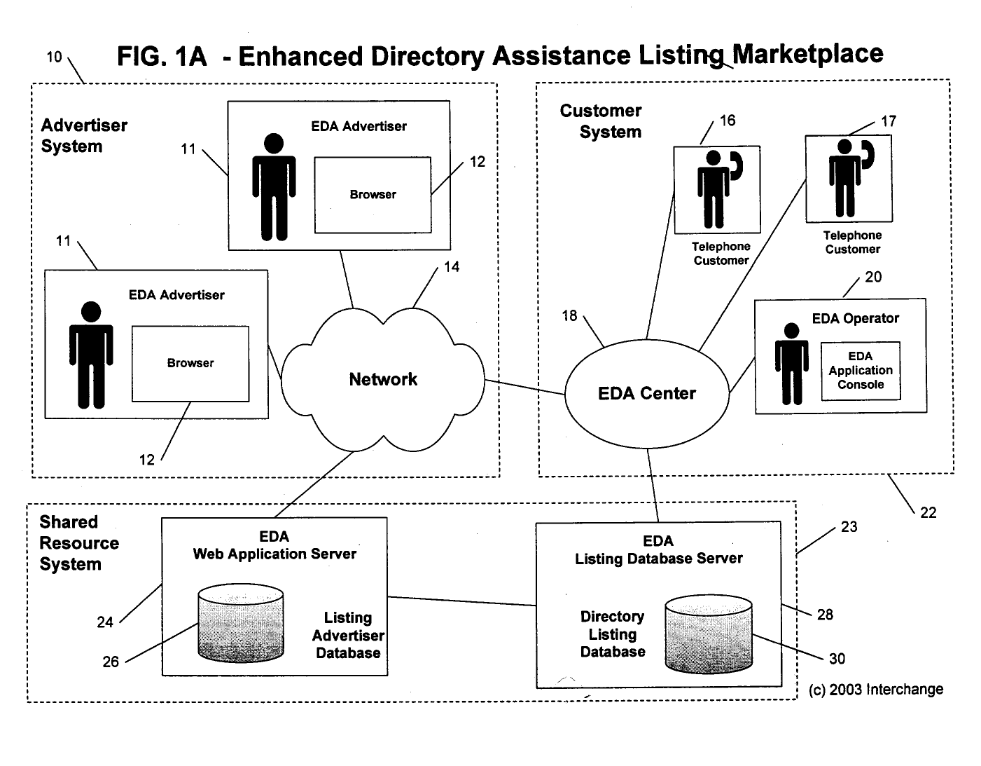

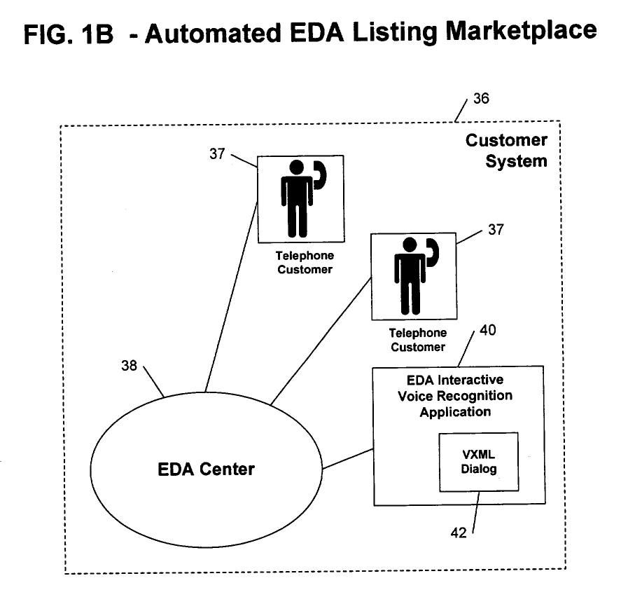

In reference to FIG. 1A, the illustration shows a basic overview of a preferred EDA Listing Marketplace implementation. In the preferred implementation, there are three basic sub system components: an Advertiser System 10, a Customer System 16 and a Shared Resource System 23. The three main components interact as follows.

Customer System

The Customer System is the part of the EDA system that a telephone customer interacts with. In a preferred implementation, a telephone customer 17 looking for a product or service connects to an EDA Center 18 by dialing a predetermined EDA service phone number. An EDA Operator 20 at the EDA Center processes the call at an EDA application console 22. The EDA application console connects to an EDA Listing Database Server (LDSvr) 28 via the EDA Center. The LDSvr then accesses telephone listings from a Directory Listing Database 30.

In the implementation, the EDA operator requests a keyword from the telephone customer that describes the product or service the customer is seeking. The operator then inputs the keyword into the EDA Application console. The console then connects to the LDSvr and performs a database lookup from the Telephone Listing Database for the requested keyword. Finally, the LDSvr then delivers the results back to the EDA operator's console, where the operator relays the results to the customer.

In a preferred implementation, the Customer Service system is automated. Referring to FIG. 1A, a Customer System 36 is using an Interactive Voice Recognition (IVR) application 40 for automation. The IVR app consists of a series of Voice XML (VXML) dialogs 42 that take the place of an EDA Operator. One VXML dialog retrieves a keyword from a telephone customer. Another VXML dialog retrieves listing results associated with the sought-after keyword. Still another VXML dynamically creates IVR selection menus that relay listing descriptions and listing referrals automatically.

Advertiser System

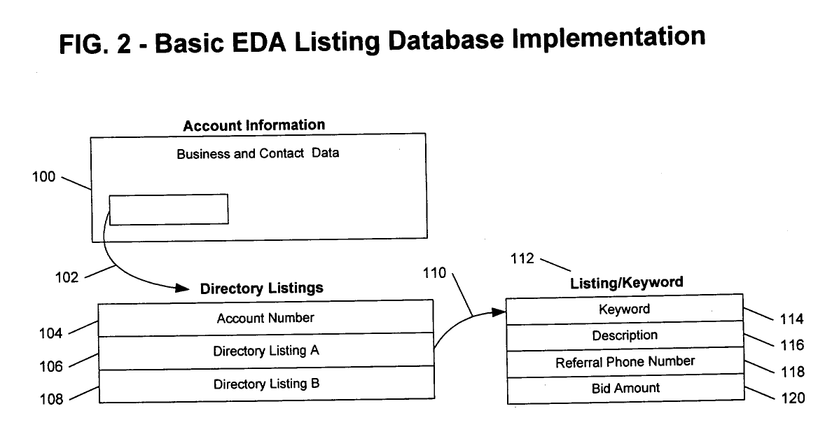

In reference to FIG. 1A, the Advertiser System is the part of the EDA system that a listing advertiser interacts with. In the preferred implementation, an EDA Advertiser 11 accesses an EDA Web Application Server 24 via a web Browser 12. The application server is hosted on a Network 14 and accesses a Listing Advertiser Database 26. In a preferred implementation, the network is the Internet. In the preferred implementation, the advertiser maintains an advertiser account as detailed in FIG. 2.

Shared Resource System

In a preferred implementation, the shared resources of an EDA system consist of the EDA Web Application Server 24 and the EDA Listing Database Server 28. The application server accesses a Listing Advertiser Database 26 and the listing server accesses a Directory Listing Database 30. The two databases are implemented as relational databases, a technology that is well known and well understood in the art, allowing customers to access directory listings via the phone. Advertisers via the network maintain the same listings.

EDA Listing Database

Referring to FIG. 2, the Listing database includes an Account Information 100 table that contains business and contact data including billing information and contact phone numbers. The implementation also includes references to telephone Directory Listings 102 that contain information records of directory listings.

A Directory Listings record includes an Account Number 104 and one or more Directory Listing fields 106 and 108. In the implementation, the fields represent unique Listing/Keyword 112 combinations where a particular advertiser listing is associated with a unique keyword 110. In the EDA system, zero or more listing records are associated with each keyword.

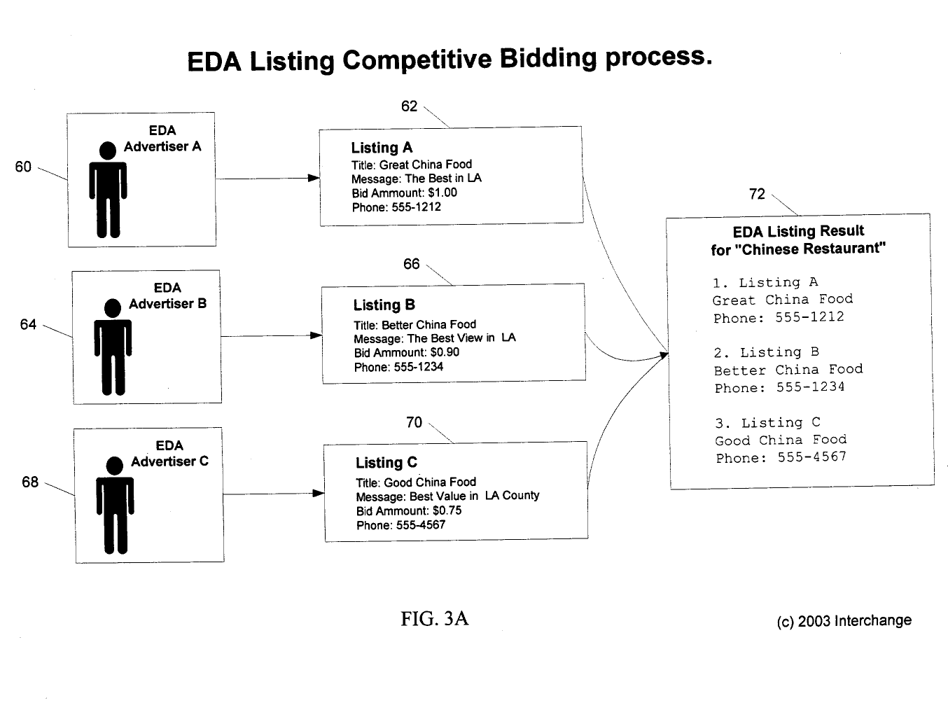

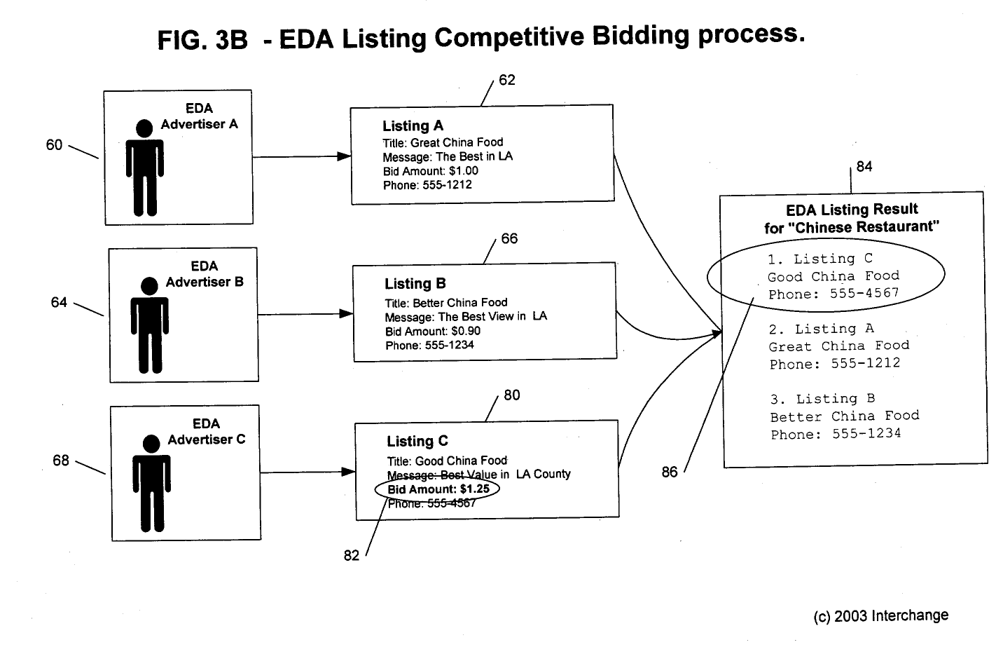

Each Listing/Keyword 112 combination includes a Keyword 114 field, a Description field 116, a Referral Phone Number 118 and a Bid Amount 120. The Bid Amount is the amount of money an advertiser will pay for an EDA telephone referral. In the disclosed implementation, the Bid Amount for each referral is controlled by a competitive auction. The auction process is detailed in FIGS. 3A and 3B.

In a preferred implementation, after getting a keyword that refers to a set of directory listings from a customer, an EDA operator enters the keyword as EDA inquiry. The EDA system returns a set of result listings in an order determined by the Bid Amount associated with each listing. The resulting list is returned in Bid Amount order, from the highest to the lowest bid.

Competitive Bidding for Position

Referring to FIG. 3A, three EDA Advertisers—Advertiser A 60, Advertiser B 64, and Advertiser C 68—own listings for the keyword “Chinese Restaurant”. Advertiser A agrees to pay $1.00 for each telephone referral to Listing A 62. Advertiser B agrees to pay $0.90 for referrals to Listing B 66. Advertiser C agrees to pay $0.75 for referrals to Listing C 70.

Performing an EDA system lookup for the keyword “Chinese Restaurant” produces the EDA Listing Result 72 where Listing A is in position I followed by Listing B and Listing C respectively.

Referring to the almost identical FIG. 3B, the three advertisers own the same listings as in FIG. 3A, but Advertiser C has raised the Bid Amount 82 on Listing C 80 to $1.25. Performing an EDA system lookup for the keyword “Chinese Restaurant” now produces a new EDA Listing Result 84. Listing C is in position 1 on the result list, followed by Listing A and Listing B respectively.

In these two figures, advertisers A and C are in competition for position on the result list. As seen in this illustration, the disclosed system and method creates a market for directory listing positions for a plurality of keywords.

In the disclosed implementation, an EDA advertiser uses an EDA Web Application to administer and maintain the advertiser's directory listings.

EDA Web Application

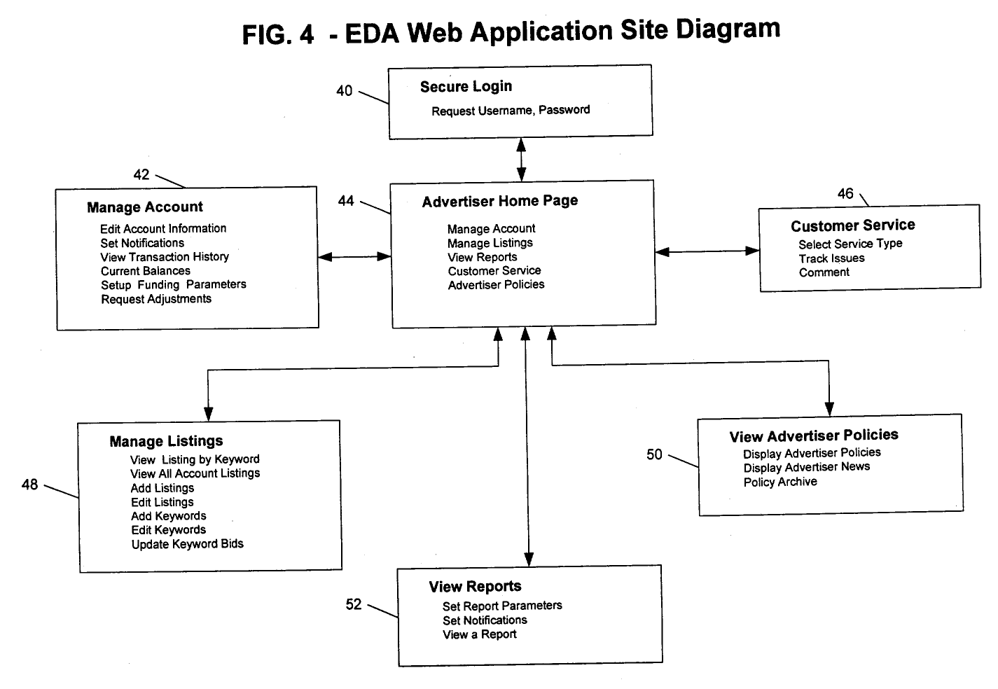

FIG. 4 details a preferred implementation of an EDA Web Application or web app

Referring to FIG. 4, the EDA Advertiser executes a Secure Login 40 by navigating to the web app Login Page. After entering a valid username and a password, the web app displays the Advertiser Home page 44.

In the implementation, the home page is an HTML encoded page with links to other EDA system functions. The functions available are:

Manage Account 42 where advertisers create and manage the business details of their EDA advertising accounts. The details include editing Account Information, viewing current account balances, viewing account transaction histories, setting up funding parameters, setting up notification parameters and requesting account adjustments;

Manage Listings 48 where advertisers monitor and maintain their listings. The maintenance includes viewing all of their listings by keyword, viewing their listings by position, adding and editing listings, adding and editing keywords and updating keyword bids.

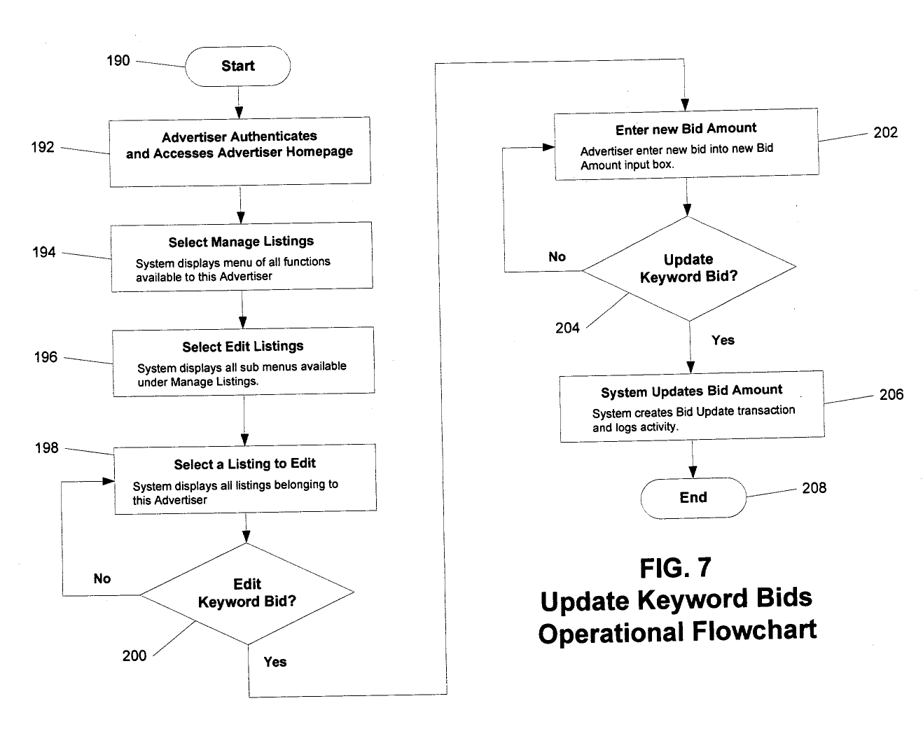

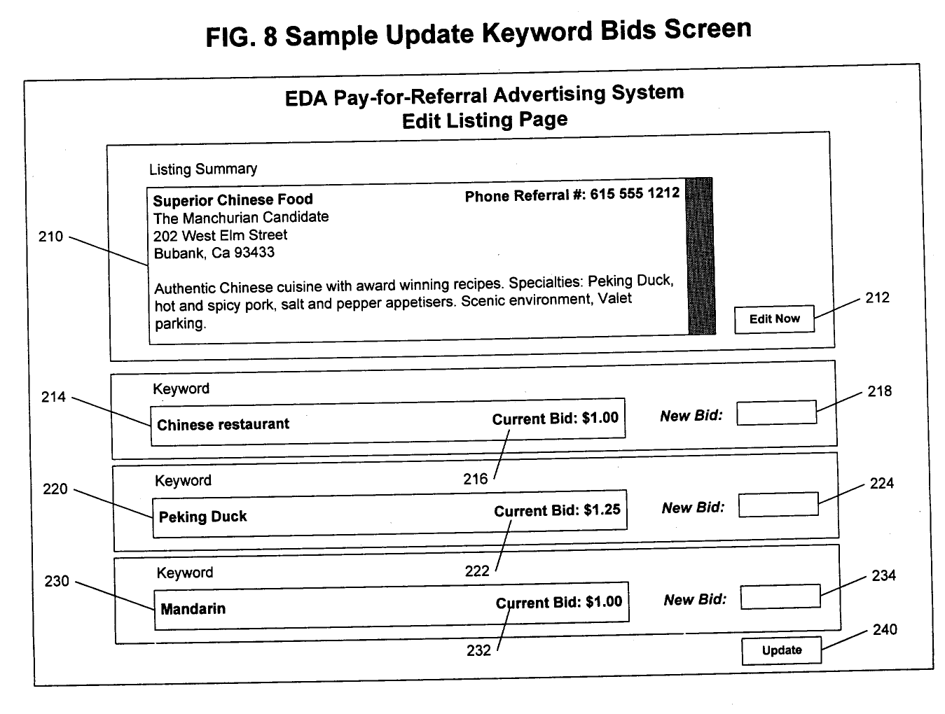

The process of updating keyword bids is unique to the invention under disclosure and is detailed in FIG. 7 and FIG. 8.

The remaining EDA system functions—View Reports 52, View Advertiser Policies 50, and Customer Service 46—are conventional web pages that provide the advertising clients with more complete service and information. This type of functionality is both well known and well understood in the art.

Account Access

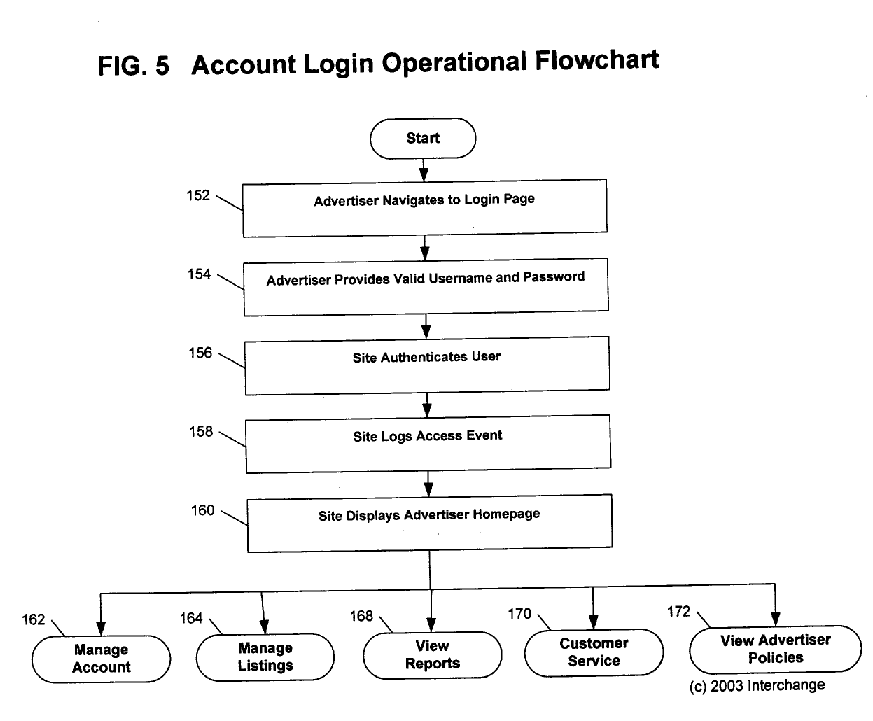

FIG. 5 shows a preferred implementation of the login and web application access procedure for an advertiser account in an EDA Web Application.

To access any function in the advertiser system, an advertiser first navigates to the Login Page 152 in a preferred implementation. After the advertiser Provides a Valid Username and Password 154, the web app Authenticates the User 156, Logs the Access Event 158 and finally Displays an Advertiser Homepage 160.

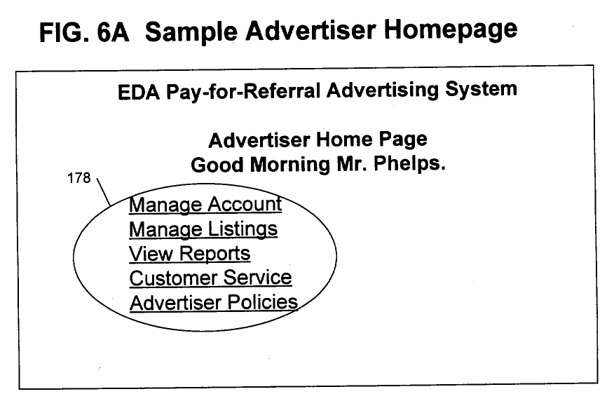

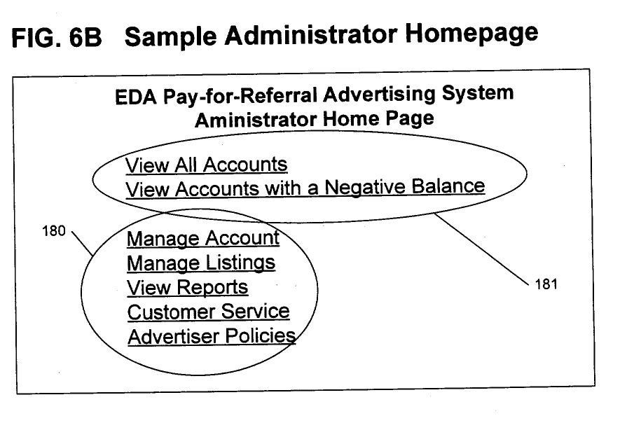

The personalized advertiser home page, a shown in FIG. 6A, is displayed, with links to all available functions including Manage Accounts 162, Manage Listings 164, View Reports 168, Customer Service 170 and View Advertiser Policies 172.

FIG. 6A shows a personalized advertiser homepage screen implementation. As is common in web-based applications, a homepage is generated for each advertising client. Any links are encoded to display data that applies only to the authenticated user.

The implementation of the homepage shown here also uses role-based security in which the functions available on the page 178 depend on the security level of the user.

FIG. 6B shows a homepage of a user who is an administrator. In reference to FIG. 6B, the only functional difference between the Advertiser Home page menu and the Administrator Menu 180 is the administrator level options 181 that allow administrators to access all accounts or only accounts needing service.

Role-based security, a technology that is well understood in the art, allows a single web access page to perform multiple functions. As illustrated in the implementation, multiple-use web pages simplify both development and maintenance of web apps.

Update Keyword Bid Process

FIG. 7 shows an Update Keyword Bids operational flowchart.

Referring to FIG. 7, after an advertiser-level user logs in successfully, the keyword bid update process Starts as shown in 190.

In a preferred implementation, the EDA web app first displays the advertiser Homepage as shown in FIG. 6A. The advertiser then selects the Manage Listings 194 option that lists the listing management functions available to advertisers.

Upon selecting the Edit Listings 196 option, the web app displays all the directory listings belonging to the advertiser. In a preferred implementation, the web app creates an HTML list of each directory listing with automatic links to a directory listing edit page.

Next, an advertiser makes a selection as shown in Select a-Listing to Edit 198. In a preferred implementation, the web app displays the contents of the selected listing, as well as all the keywords associated with the listing as shown in FIG. 8.

Referring to again to FIG. 7, in a preferred implementation if the advertiser decides to Edit the Keyword Bid 200, the advertiser Enters a New Bid Amount 202. After making all desired updates, the advertiser can decide to Update Keyword Bids 204.

At this point in the preferred implementation, the EDA web app updates the Bid Amounts 206 for the desired keywords, logs the new activity and ends the update process.

FIG. 8 shows a preferred implementation of an Update Keywords Bids Screen.

Referring to FIG. 8, the Listing Summary 210 for the implementations displays the details of the selected directory listing. In the implementation, this information can be edited by clicking on the Edit Now button 212.

The implementation shows three keyword bid boxes 213, 219 and 229. Each keyword 214, 220, and 230 is grouped with an associated Current Bid 216, 222, and 232. This bid amount can be changed by entering a new amount into the appropriate New Bid HTML input boxes 218, 224, and 234. The bids associated with the keywords are updated upon clicking on the Update button 240.

The implementation of the web app disclosed allows advertiser users to maintain and update both the content and paid advertising amount independently of an administrator. In the preferred implementation therefore, the system and processes disclosed allow the creation and maintenance of an enhanced directory assistance marketplace.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. A method to control aspects of a telephone directory listing in an electronic auction, comprising
receiving initial bid amounts of individual listing referrals for a set of directory listings associated with a specific keyword;
calculating the increased bid amount necessary to appear in the first position of the result list;
receiving an adjustment to the bid amount for a directory listing;
updating the bid amount associated with a keyword and a directory listing;
recalculating the new position in the result list.

2. A method of generating a list of phone numbers substantially in real time in response to a directory assistance request from a telephone customer using a computer network comprising:
maintaining a database including a plurality of directory listings, wherein each listing is associated with a referral phone number, at least one keyword and a bid amount a directory listing owner is willing to pay for a single telephone referral;
receiving a directory assistance request in the form of a keyword from the customer;
identifying the directory listings having keyword terms generating a match with the request;
ordering the identified directory listings into a phone number result list in accordance with the values of the bid amounts for the identified directory listings.
